(19) United States
(12) Patent Application Publication
(10) Pub. No.: US 2005/0231439 A1
(43) Pub. Date: Oct. 20, 2005

(54) Antenna switch circuit, and composite high frequency part and mobile communication device using the same

(75) Inventors: Atsushi Suwa, Takatsuki-shi (JP); Tadayoshi Nakatsuka, Toyonaka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/103,550

(22) Filed: Apr. 12, 2005

(30) Foreign Application Priority Data
Apr. 16, 2004 (JP) 2004-121011

(51) Int. Cl. H01Q 3/24

(52) U.S. Cl. 343/876

(57) ABSTRACT

First and second through-side field effect transistors are connected between first and second high frequency signal input/output terminals, and an antenna, respectively. The first and the second high frequency signal input/output terminals are connected with one end of the first and the second shunt-side field effect transistors, respectively. A series resonant circuit including a shunt capacitor and a bonding wire is connected between the other end of the first and the second shunt-side field effect transistors, and a ground.

### BACKGROUND OF THE INVENTION

1. Field of the Invention

The present invention relates to an antenna switch circuit, and a composite high frequency part and a mobile communication device using the same.

2. Description of Related Art

A communication system of a mobile phone includes various modes, such as a GSM (Global System for Mobile Communications) mode and a DCS (Digital Cellular System) mode mainly used in Europe, and a PCS (Personal Communication Service) mode mainly used in North America.

In order to allow a user to use a mobile phone in various regions in the world, the user must carry a required number of mobile phones compatible with the respective modes or must carry one multiband phone compatible with a plurality of communication systems. In the latter case, in order to allow one mobile phone to provide communication through a plurality of communication systems, the phone may be configured by using components of the respective communication systems. However, both of the volume and the weight of the mobile phone are increased in proportion to the number of communication systems, so that such a mobile phone is not suitable for a mobile application. Therefore, a small and lightweight high frequency part compatible with a plurality of systems has been required.

FIG. 4 illustrates an example of an antenna switch circuit of a mobile phone provided on a GaAs substrate. As shown in FIG. 4, this antenna switch circuit has a Single Pole Dual Throw (SPDT) configuration in which two signal paths of one signal path between an antenna ANT and a high frequency signal input/output terminal T1 and another signal path between the antenna ANT and a high frequency signal input/output terminal T2 are switched. Thus, this antenna switch circuit is configured by through-side field effect transistors QT1 and QT2, shunt-side field effect transistors QS1 and QS2, and shunt capacitors CS1 and CS2. The through-side field effect transistors QT1 and QT2 and the shunt-side field effect transistors QS1 and QS2 are on/off-controlled in accordance with control signals supplied to the control terminals CT1, CT3, CT2, and CT4.

The shunt-side field effect transistors QS1 and QS2 are provided in order to secure isolation.

FIG. 5 illustrates a portion A surrounded by a broken line of FIG. 4 in more detail. The antenna switch circuit in FIG. 5 is configured by the through-side field effect transistor QT1, the shunt-side field effect transistor QS1, and the shunt capacitor CS1. Although FIG. 4 illustrates the through-side field effect transistor QT1 and the shunt-side field effect transistor QS1 as separate field effect transistors, they are actually configured by a serial connection circuit including a plurality of field effect transistors, respectively.

When the signal path from the antenna ANT to, for example the high frequency signal input/output terminal T1 is brought into conduction, the control terminal CT1 is applied with a level H voltage (e.g., Vctrl=3 V) controlled by a control circuit (not shown). As a result, the through-side field effect transistor QT1 is turned on.

On the other hand, the shunt-side field effect transistor QS1 is operated in a reverse manner to that of the through-side field effect transistor QT1. When the signal path from the antenna ANT to, for example the high frequency signal input/output terminal T1 is brought into conduction, the control terminal CT2 is applied with a level L voltage (e.g., Vctrl=0 V) controlled by the control circuit. As a result, the shunt-side field effect transistor QS1 is turned off.

When the signal path from the antenna ANT to the high frequency signal input/output terminal T1 is interrupted, the control circuit applies the level L voltage to the control terminal CT1 and applies the level H voltage to the control terminal CT2. As a result, the signal path from the antenna ANT to the high frequency signal input/output terminal T1 has an improved isolation characteristic.

By switching voltages applied to the control terminals CT1 and CT2 as described above, ON and OFF states of the through-side field effect transistor QT1 and the shunt-side field effect transistor QS1 are switched to switch the signal paths.

The field effect transistor QT2 and the field effect transistor QS2 operate in a manner similar to above.

FIG. 10 illustrates the isolation characteristic between the high frequency signal input/output terminal T1 and the high frequency signal input/output terminal T2 in the related art when the signal path between the high frequency signal input/output terminal T1 and the antenna ANT is brought into conduction.

Patent Reference 1: Japanese Laid-open Patent Application Publication No. H09-181588

In order to secure isolation, the shunt capacitor needs to have a low impedance in a high frequency. Thus, the shunt capacitor desirably has a capacitance of at least 5 pF or more. In order to have the compatibility with a multiband application as described above, the same number of shunt capacitors as that of paths are required. Therefore, an area of the shunt capacitors on the substrate increases in accordance with an increase in the number of the paths. For example, in the antenna switch circuit having a dual band-compatible Single Pole 4 Throw (SP4T) configuration, four shunt capacitors are needed. In the antenna switch circuit having a triple band-compatible Single Pole 5 Throw (SP5T) configuration, five shunt capacitors are needed. Therefore, such configurations hinders downsizing of the mobile phone.

### SUMMARY OF THE INVENTION

It is an object of the present invention to provide a small-sized and lightweight antenna switch circuit that realizes a small-sized and lightweight mobile phone compatible with a further development of a multiband application in the future.

It is another object of the present invention to provide a highly functional antenna switch circuit that realizes secure of isolation that is difficult in a multiband application.

In order to solve the above problems, an antenna switch circuit according to a first aspect of the present invention includes: first to n-th high frequency signal input/output terminals where n is a positive integer equal to or larger than two; an antenna; first to n-th through-side field effect transistors connected between the first to n-th high frequency signal input/output terminals and the antenna, respectively; first to n-th shunt-side field effect transistors each having one end connected to the first to n-th high frequency signal input/output terminals, respectively; and a series resonant circuit, which includes a shunt capacitor and an inductor, having one end commonly connected to the other ends of the first to n-th shunt-side field effect transistors and having other end connected to a ground.

According to this configuration, the other ends of the first to n-th shunt-side field effect transistors are commonly connected, and are further connected to the ground via the series resonant circuit including the shunt capacitor and the inductor. Consequently, the number of the shunt capacitors may be reduced to make the antenna switch circuit smaller in size and lighter in weight, thus providing a small-sized and lightweight mobile phone.

Furthermore, since the series resonant circuit is configured by the shunt capacitor and the inductor, it is possible to sufficiently reduce the impedance between the shunt-side field effect transistor and the ground by the resonance. Thus, an isolation characteristic may be improved.

In the antenna switch circuit according to the present invention, the series resonant circuit may preferably have a resonant frequency that is set within ±25% of a frequency of a high frequency signal inputted from any one of the first to n-th high frequency signal input/output terminals or from the antenna.

In the antenna switch circuit according to the present invention, the inductor may be configured by a bonding wire for connecting between the shunt capacitor and the ground.

Incidentally, the inductor may be configured by the bonding wire having one end thereof connected to the shunt capacitor, and the wiring for connecting between the other end of the bonding wire and the ground.

The shunt capacitor, the bonding wire, and the wiring may be connected in an arbitrary order.

In the antenna switch circuit according to the present invention, a plurality of series resonant circuits (e.g., two series resonant circuits) may preferably be provided in parallel.

The shunt capacitor may be formed, for example on a GaAs substrate.

The inductor i.e. wiring may be formed, for example on the GaAs substrate.

The shunt capacitor may be formed, for example in an interior of a lamination substrate.

The inductor i.e. wiring may be formed, for example on a surface layer or in the interior of the lamination substrate.

The shunt capacitor may be configured, for example by a chip component.

First to n-th serial connection circuits of pluralities of through-side field effect transistors may preferably be used instead of the first to n-th through-side field effect transistors, and first to n-th serial connection circuits of pluralities of shunt-side field effect transistors may preferably be used instead of the first to n-th shunt-side field effect transistors.

According to a second aspect of the present invention, the composite high frequency part is configured by any one of the above antenna switch circuits.

According to a third aspect of the present invention, the mobile communication device is configured by any one of the above antenna switch circuits.

According to a forth aspect of the present invention, the mobile communication device is configured by the above composite high frequency part.

According to the second to the fourth aspects of the present invention, the antenna switch circuit is also used, so that the effect similar to that of the above antenna switch circuit may be provided.

As described above, according to the present invention, the small-sized and lightweight antenna switch circuit can be provided even when the mobile phone is applied in a multiband application, so that it is possible to contribute to realizing a mobile phone which is small in size and light in weight and is compatible with the multiband application. Further, by proving the series resonant circuit in the shunt circuit, it is possible to realize the isolation characteristic that is higher than that of the related art. Furthermore, since a plurality of series resonant circuits (e.g., two series resonant circuits) are provided in parallel, the higher isolation characteristic across the wider band is realized, thus contributing to reduce the size and improve a performance of the device.

### BRIEF DESCRIPTION OF THE DRAWINGS

FIG. 1 is a circuit diagram illustrating an antenna switch circuit having an SPDT configuration according to a first embodiment of the present invention;

FIG. 2 is a circuit diagram illustrating the antenna switch circuit having the SPDT configuration according to a second embodiment of the present invention;

FIG. 3 is a circuit diagram illustrating the antenna switch circuit having the SPDT configuration according to a third embodiment of the present invention;

FIG. 4 is a circuit diagram illustrating the antenna switch circuit having the SPDT configuration of the related art;

FIG. 5 is a circuit diagram illustrating in detail a portion surrounded by a broken line in FIG. 4;

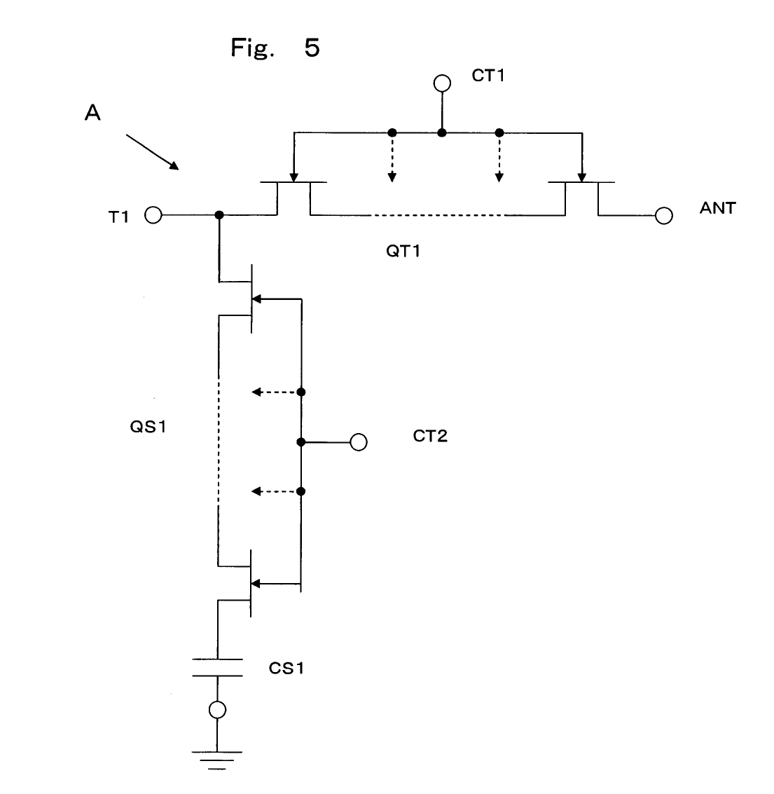

FIG. 6 is an equivalent circuit diagram illustrating the antenna switch circuit in which a shunt capacitor is commonly used;

FIG. 7 is a characteristic diagram illustrating an isolation characteristic in the antenna switch circuit of the first embodiment of the present invention;

FIG. 8 is a characteristic diagram illustrating the isolation characteristic in the antenna switch circuit of the second embodiment of the present invention;

FIG. 9 is a characteristic diagram illustrating the isolation characteristic in the antenna switch circuit of the third embodiment of the present invention; and

FIG. 10 is a characteristic diagram illustrating the isolation characteristic in the antenna switch circuit of the related art.

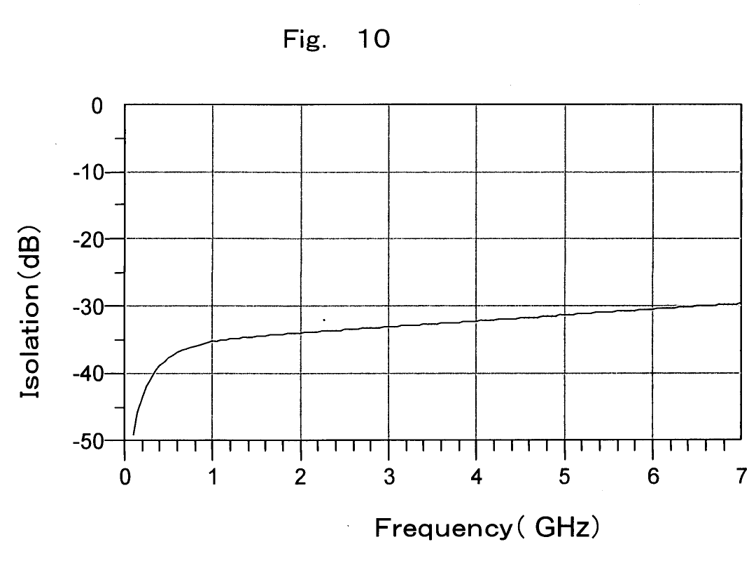

### DETAILED DESCRIPTION OF THE PREFERRED EMBODIMENTS

Hereinafter, embodiments of a small-sized and lightweight antenna switch circuit according to the present invention will be described in detail with reference to drawings.

### First Embodiment

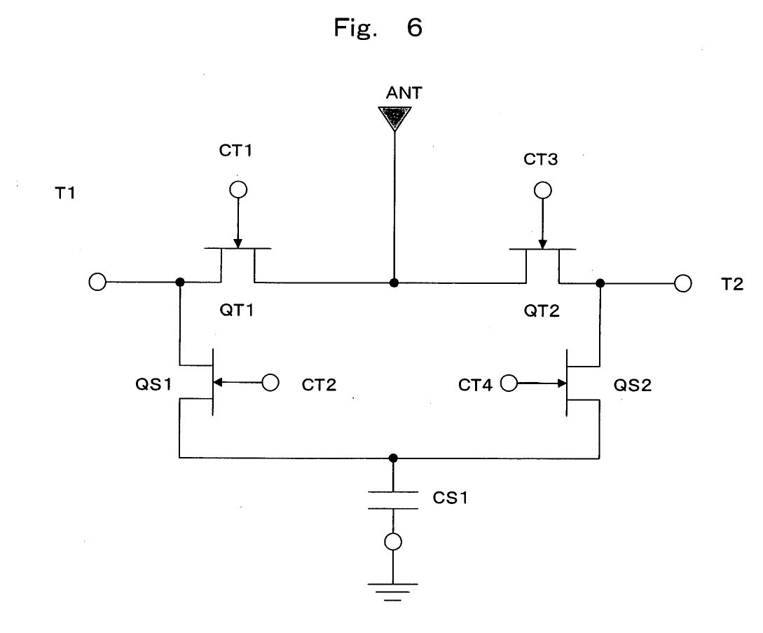

FIG. 6 is an equivalent circuit diagram illustrating an antenna switch circuit in which a shunt capacitor is commonly used. In FIG. 6, shunt-side field effect transistors QS1 and QS2 are connected to an upper electrode (i.e., one end) of the single shunt capacitor CS1. A lower electrode of the shunt capacitor CS1 (i.e., the other end) is grounded.

Supposing that the shunt capacitor CS1 of the related art has the capacitance C and the shunt capacitor CS1 of this embodiment has the capacitance C′. When C=C′ is established, a signal inputted via a high frequency signal input/output terminal T1 passes through the upper electrode of the common shunt capacitor CS1 and is leaked to a high frequency signal input/output terminal T2. This deteriorates an isolation characteristic when compared to the related art. Thus, a ground side of the shunt capacitor CS1 must have a lower impedance.

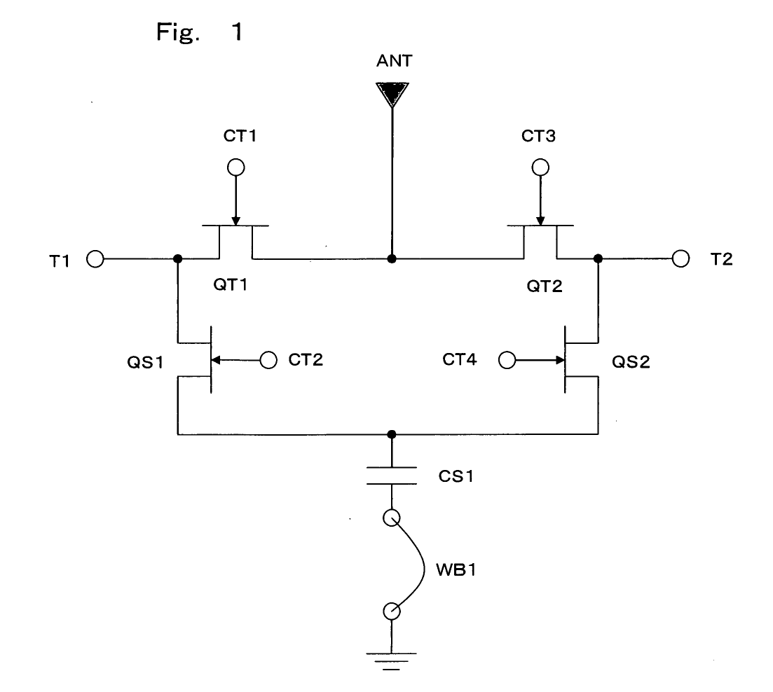

FIG. 1 is a circuit diagram illustrating a configuration of a first embodiment of the antenna switch circuit of a mobile phone according to the present invention. In FIG. 1, the shunt-side field effect transistors QS1 and QS2 are connected to the upper electrode of the single shunt capacitor CS1 and are grounded via the shunt capacitor CS1 and a bonding wire WB1. The bonding wire WB1 may be assumed as an inductor equivalently and thus the shunt capacitor CS1 and the bonding wire WB1 configure a series resonant circuit.

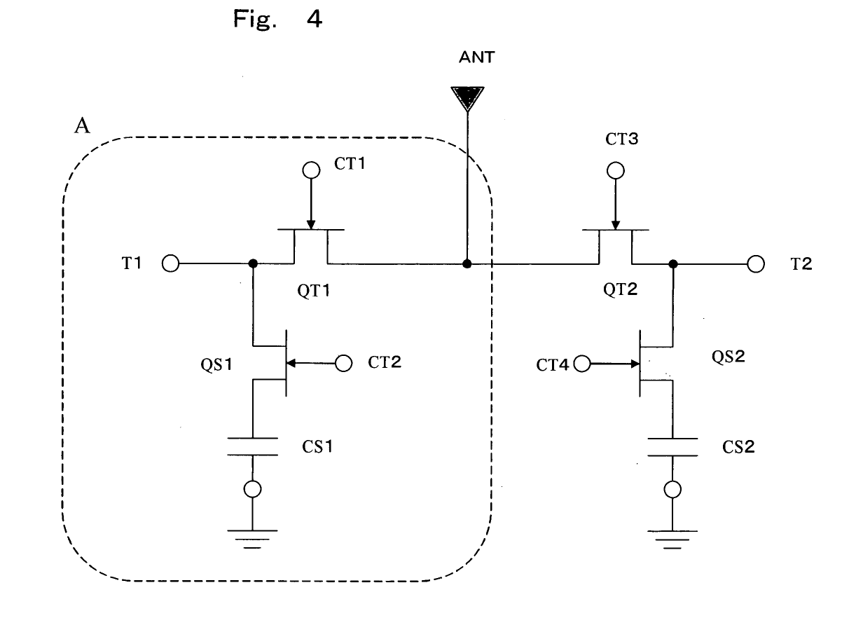

In the antenna switch circuit of this embodiment, at least the through-side field effect transistors QT1 and QT2 and the shunt-side field effect transistors QS1 and QS2 are provided on a GaAs substrate. The shunt capacitor CS1 may also be provided on the GaAs substrate or may be provided in a lamination substrate of Low Temperature Co-fired Ceramics (LTCC). Alternatively, the shunt capacitor CS1 may also be provided as an external chip component. The through-side field effect transistors QT1 and QT2 have the similar structure to that in the related art of FIG. 4. The switching operation of the through-side field effect transistors QT1 and QT2 and the shunt-side field effect transistors QS1 and QS2 are similar to that in the related art of FIG. 4 and thus will not be described further.

When values of the shunt capacitor CS1 and the bonding wire WB1 are appropriately selected so as to have attenuation with regards to the frequency of the signal inputted to the high frequency signal input/output terminal T1, the isolation characteristic can be improved. For example, a case will be described where the signal inputted via the high frequency signal input/output terminal T1 has a frequency f1 and a signal path between the high frequency signal input/output terminal T1 and an antenna ANT is brought into conduction. When the signal path between the high frequency signal input/output terminal T1 and the antenna ANT is brought into conduction, the through-side field effect transistor QT1 and the shunt-side field effect transistor QS2 are in an ON state while the through-side field effect transistor QT2 and the shunt-side field effect transistor QS1 are in an OFF state.

The signal having the frequency f1 inputted via the high frequency signal input/output terminal T1 is outputted from the antenna ANT. On the other hand, the through-side field effect transistor QT2 is in the OFF state but has some signal leakage due to the influence by, for example parasitic capacitance. In order to allow this leakage to shunt to the ground, the shunt-side field effect transistor QS2 is in the ON state. Then, the series resonant circuit configured by the shunt capacitor CS1 and the bonding wire WB1 is provided to have the resonant frequency f1, thereby improving the isolation characteristic between the high frequency signal input/output terminal T1 and the high frequency signal input/output terminal T2.

Next, a series resonant frequency will be described. When assuming that the shunt capacitor CS1 has a capacitance C and the bonding wire WB1 has an inductance component L, the resonant frequency f1 is represented by the following equation.
f1=1/(2π(LC)^{1/2}) (1)

When this condition is satisfied, the series resonant circuit has the extremely low impedance in the series resonant frequency. When assuming that f1=3 GHz for example, L=1 nH and C=2.8 pF are established. By appropriately selecting values of the inductance component L and the capacitance C as described above, the isolation to an arbitrary frequency can be improved. The values of the inductance component L and the capacitance C are arbitrary. However, an increase in the value of the capacitance C causes an increase in a chip area, thus hindering the downsizing. Therefore, the capacitance C in this example is set at 5 pF or less.

On the other hand, the inductance component of the bonding wire WB1 is generally about 0.5 nH to 1.5 nH and thus is at 1 nH in this example. The shunt capacitor CS1 of the series resonant circuit and the bonding wire WB1 as the inductor may be connected in an arbitrary order and any order shows the similar characteristic. Thus, when the GaAs substrate has thereon the field effect transistors QT1, QT2, QS1, and QS2 and a shunt capacitor for example, the shunt-side field effect transistors QS1 and QS2 are grounded via the shunt capacitor CS1 and the bonding wire WB1 in this order. On the other hand, when the shunt capacitor CS1 is provided in the lamination substrate of the Low Temperature Co-fired Ceramics (LTCC) or is provided as the external chip component, the shunt-side field effect transistors QS1 and QS2 are grounded via the bonding wire WB1 and the shunt capacitor CS1 in this order.

According to this embodiment, a switch having an SPDT configuration shown in FIG. 4 (that has been configured by the two shunt capacitors CS1 and CS2 in the related art) can be realized by only one shunt capacitor CS1, thus contributing to the downsizing of the mobile phone. By adopting a series resonant circuit configuration, the higher isolation characteristic can also be realized.

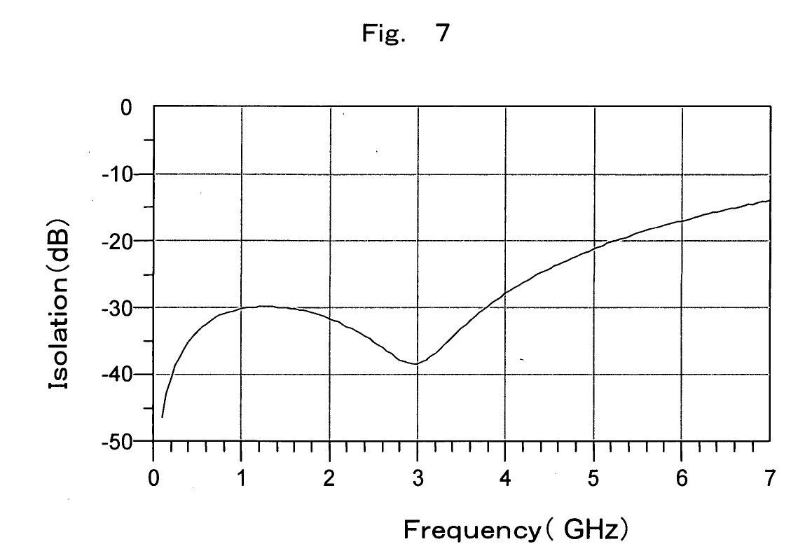

FIG. 7 illustrates the isolation characteristic between the high frequency signal input/output terminal T1 and the high frequency signal input/output terminal T2 when the signal path between the high frequency signal input/output terminal T1 and the antenna ANT is brought into conduction in this embodiment.

### Second Embodiment

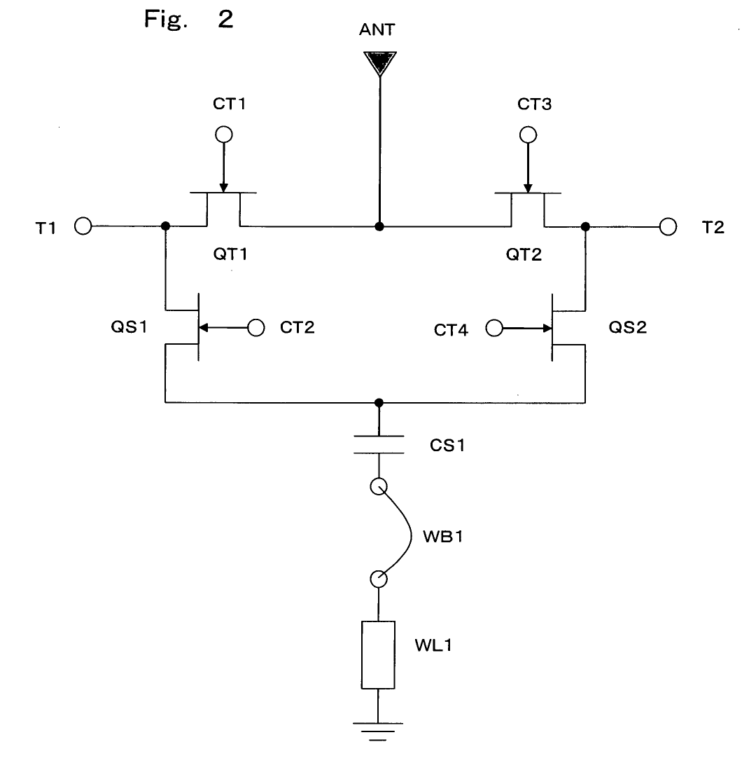

FIG. 2 is a circuit diagram illustrating a configuration of a second embodiment of an antenna switch circuit according to the present invention. In FIG. 2, the shunt-side field effect transistors QS1 and QS2 are connected to the upper electrode of the single shunt capacitor CS1 and are grounded via the shunt capacitor CS1, the bonding wire WB1, and a wiring WL1. The bonding wire WB1 and the wiring WL1 can be assumed as an inductor equivalently and thus the shunt capacitor CS1, the bonding wire WB1, and the wiring WL1 configure the series resonant circuit.

In the antenna switch circuit of this embodiment, at least the shunt-side field effect transistors QS1 and QS2 and the through-side field effect transistors QT1 and QT2 are provided on the GaAs substrate. The shunt capacitor CS1 may be provided on the GaAs substrate or may also be provided in the lamination substrate of the Low Temperature Co-fired Ceramics (LTCC). Alternatively, the shunt capacitor CS1 may also be provided as the external chip component. The wiring WL1 may be provided either on the GaAs substrate or on the lamination substrate. The through-side field effect transistors QT1 and QT2 have the structure similar to that of the related art of FIG. 4. The switching operation of the through-side field effect transistors QT1 and QT2 and the shunt-side field effect transistors QS1 and QS2 are similar to that in the related art of FIG. 4 and thus will not be described further.

In the configuration shown in the first embodiment, in order to have an attenuation pole with a relatively low frequency (e.g., 2 GHz), the capacitance C of 4.2 pF is required even when the inductance L by the bonding wire WB1 is 1.5 nH. Therefore, the shunt capacitor CS1 has substantially a similar value of magnitude as that of the related art (5 pF).

In order to improve the isolation characteristic even to a lower frequency without causing the increase in the area, the second embodiment uses, in addition to the inductance component of the bonding wire WB1, the inductance component of the wiring WL1.

In order to improve the isolation characteristic at 2 GHz in this configuration, when the shunt capacitor CS1 is provided with the capacitance C of 3 pF, a total inductance component of 2.1 nH is required as the sum of the inductance components of the bonding wire WB1 and the wiring WL1.

As described above, the bonding wire WB1 generally has the inductance component of about 0.5 nH to 1.5 nH. Thus, the shortage of the inductance component of 1.6 nH to 0.6 nH is compensated by the use of the inductance component of the wiring WL1 that can be configured with the relatively small area when compared to that of a capacitor. The configuration as described above can realize the attenuation pole of 2 GHz.

By compensating the shortage of the inductance component of the bonding wire WB1 by the inductance component of the wiring WL1, the attenuation pole can be set to a desired frequency.

In the series resonant circuit, the shunt capacitor, the bonding wire configuring the inductor, and the wiring configuring the inductor may be connected in an arbitrary order and the similar characteristic is shown in any order. Thus, when only the shunt capacitor CS1 is provided, for example on the GaAs substrate, the shunt-side field effect transistors QS1 and QS2 are grounded via the shunt capacitor CS1, the bonding wire WB1, and the wiring WL1 provided on a surface layer or in the interior of the LTCC in this order. When the GaAs substrate has thereon the field effect transistors QT1, QT2, QS1, and QS2, the shunt capacitor CS1, and the wiring WL1, the shunt-side field effect transistors QS1 and QS2 are grounded via the shunt capacitor CS1, the wiring WL1, and the bonding wire WB1 in this order.

When the GaAs substrate has thereon the field effect transistors QT1, QT2, QS1, and QS2 and the wiring WL1 only, the shunt-side field effect transistors QS1 and QS2 are grounded via the wiring WL1, the bonding wire WB1, and the shunt capacitor CS1 provided in the LTCC in this order.

When the GaAs substrate has thereon only the field effect transistors QT1, QT2, QS1, and QS2 without having thereon any other components, the shunt-side field effect transistors QS1 and QS2 are grounded via the bonding wire WB1, the wiring WL1 provided on the surface layer or in the interior of the LTCC, and the shunt capacitor CS1 provided in the LTCC in this order. Alternatively, the shunt-side field effect transistors QS1 and QS2 are grounded via the bonding wire WB1, the shunt capacitor CS1 provided in the LTCC, and the wiring WL1 provided on the surface layer or the interior of the LTCC in this order. When no shunt capacitor CS1 is provided on the GaAs substrate, the similar effect is obtained even when the shunt capacitor CS1 is configured by the chip component.

According to this embodiment, the switch having the SPDT configuration shown in FIG. 4 (that has been configured by the two shunt capacitors CS1 and CS2 in the related art) to be realized by one shunt capacitor CS1, thus contributing to the downsizing of the mobile phone. By adopting the series resonant circuit configuration using the inductor of the wiring WL1, the high isolation characteristic even in the lower frequency can be realized.

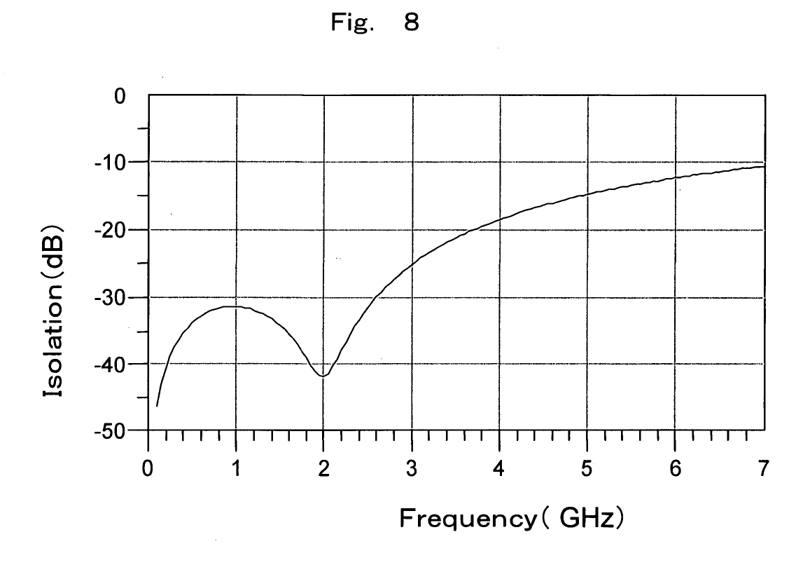

FIG. 8 illustrates the isolation characteristic between the high frequency signal input/output terminal T1 and the high frequency signal input/output terminal T2 when the signal path between the high frequency signal input/output terminal T1 and the antenna ANT in this embodiment is brought into conduction.

### Third Embodiment

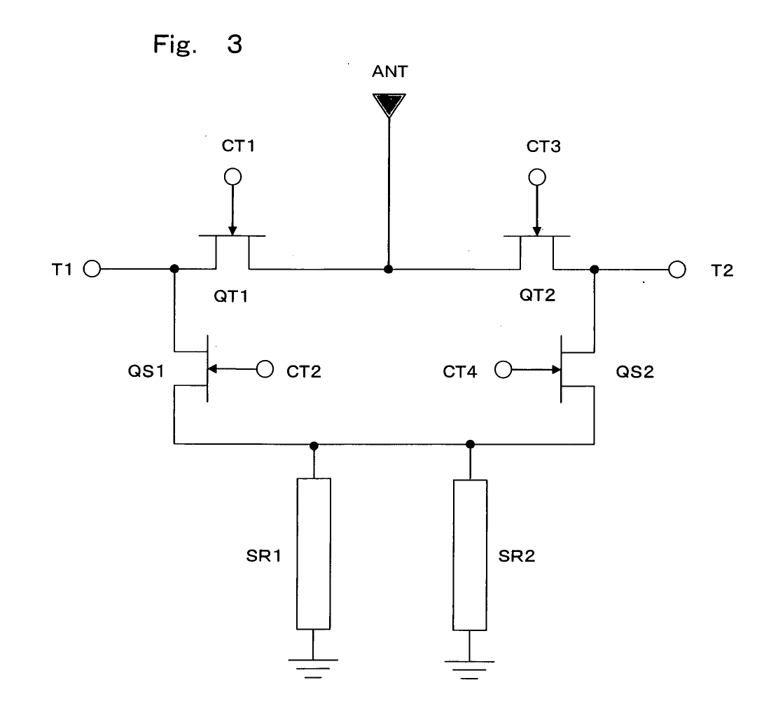

FIG. 3 is a circuit diagram illustrating a configuration of a third embodiment of an antenna switch circuit according to the present invention. In this embodiment, the two series resonant circuits described in the first and the second embodiments are arranged in parallel. Specifically, the shunt-side field effect transistors QS1 and QS2 are grounded via two series resonant circuits SR1 and SR2 connected in parallel. Both of the above two series resonant circuits SR1 and SR2 have attenuation poles set at 2 GHz.

These two series resonant circuits SR1 and SR2 can be provided with the same constant value, thereby securing the isolation across a wide band. As a result, the high isolation characteristic can be realized, for example in both of a GSM band (900 MHz), and a PCS band (1900 MHz) or a DCS band (1800 MHz). Specifically, by providing the two series resonant circuits SR1 and SR2 having the same attenuation pole in parallel, the bandwidth of the pole widens, thereby securing the isolation across the wide band.

When three or more series resonant circuits are provided in parallel, the high isolation can be secured across the wider band. At the same time, this parallel arrangement of three or more series resonant circuits increases the area occupied by the series resonant circuits. The number of series resonant circuits is determined based on the required value of the isolation.

As shown by Formula (1), the values of the inductance component L and the capacitance C increases as the frequency decreases. Consequently, the area occupied by the inductance L and the capacitance C on the substrate can not be ignored, which hinders the downsizing. However, the use of the two series resonant circuits SR1 and SR2 can secure the isolation across the wide band. Thus, even when the center of the attenuation pole is set at the frequency higher than a desired frequency, the isolation characteristic can be improved in a desired frequency.

According to this embodiment, the switch having the SPnT configuration (that has been configured by the shunt capacitors n in number in the related art) can be realized by two shunt capacitors, thus contributing to the downsizing of a mobile phone. The configuration of two series resonant circuits can also realize a high isolation characteristic in a wider band.

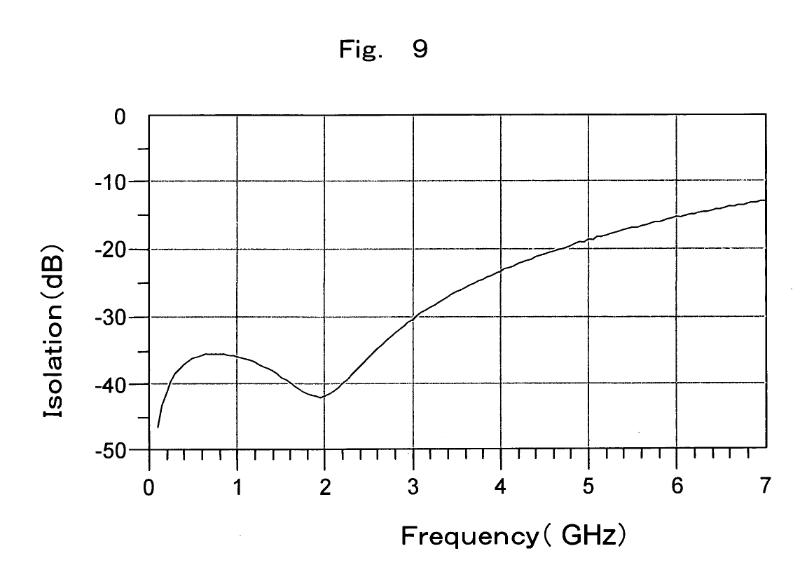

FIG. 9 illustrates the isolation characteristic between the high frequency signal input/output terminal T1 and the high frequency signal input/output terminal T2 when the signal path between the high frequency signal input/output terminal T1 and the antenna ANT in this embodiment is brought into conduction.

In FIG. 7 to FIG. 9 showing the isolation characteristics in the first to the third embodiments of the present invention, the attenuation pole configured by the series resonant circuit can secure 30 dB in the bandwidth of about 25% of the desired frequency. Specifically, the sufficient isolation can be secured when the attenuation pole can be configured within a range of ±25% with regards to the center of the desired frequency. The term “desired frequency” refers to the frequency of the high frequency signal for which a path is switched by the present antenna switch circuit, and refers to the frequency of the high frequency signal inputted via a first or a second high frequency signal input/output terminal T1 or T2 or the antenna ANT.

According to the present invention, the antenna switch circuit having the high isolation characteristic can be realized without decreasing a yield, even when the production has variation.

Although the first to third embodiments of the present invention have shown the antenna switch circuit having the SPDT configuration, the present invention can also be applied to the antenna switch circuit having an SPnT configuration in which an arbitrary number of input/output terminals is provided. In the above-mentioned antenna switch circuit, the effect for reducing the area occupied by the capacitor enhances as the number of the paths increases. The similar effect can also be obtained even when the respective through-side field effect transistors QT1 and QT2 are configured by the serial connection circuits of a plurality of field effect transistors, and the respective shunt-side field effect transistors QS1 and QS2 are configured by the serial connection circuits of a plurality of field effect transistors.

A composite high frequency part configured by adopting the antenna switch circuit of the respective embodiments described above can also provide the effect similar to that provided by the above antenna switch circuit. A mobile communication device using the above antenna switch circuit or the above composite high frequency part can also provide the effect similar to that provided by the above antenna switch circuit.

### INDUSTRIAL AVAILABILITY

The antenna switch circuit according to the present invention realizes the small-sized and lightweight mobile phone. The antenna switch circuit of the present invention has the effect of securing the isolation characteristic when the mobile phone is used in a multiband application. The antenna switch circuit according to the present invention is applicable as, for example the antenna switch circuit for a mobile phone having a multiband configuration.

1. An antenna switch circuit, comprising:
first to n-th high frequency signal input/output terminals where n is a positive integer equal to or larger than two;
an antenna;
first to n-th through-side field effect transistors connected between said first to n-th high frequency signal input/output terminals and said antenna, respectively;
first to n-th shunt-side field effect transistors each having one end connected to said first to n-th high frequency signal input/output terminals, respectively; and
a series resonant circuit, which includes a shunt capacitor and an inductor, having one end commonly connected to the other ends of said first to n-th shunt-side field effect transistors and having other end connected to a ground.

2. The antenna switch circuit according to claim 1, wherein said series resonant circuit has a resonant frequency that is set within ±25% of a frequency of a high frequency signal inputted from any one of said first to n-th high frequency signal input/output terminals or from said antenna.

3. The antenna switch circuit according to claim 1, wherein the inductor is configured by a bonding wire for connecting between said shunt capacitor and said ground.

4. The antenna switch circuit according to claim 1, wherein said inductor is configured by the bonding wire having one end thereof connected to said shunt capacitor, and the wiring for connecting between the other end of said bonding wire and said ground.

5. The antenna switch circuit according to claim 4, wherein said shunt capacitor, said bonding wire, and said wiring are connected in an arbitrary order.

6. The antenna switch circuit according to claim 1, wherein a plurality of said series resonant circuits are provided in parallel.

7. The antenna switch circuit according to claim 1, wherein said shunt capacitor is formed on a GaAs substrate.

8. The antenna switch circuit according to claim 4, wherein said wiring is formed on said GaAs substrate.

9. The antenna switch circuit according to claim 1, wherein said shunt capacitor is formed in an interior of a lamination substrate.

10. The antenna switch circuit according to claim 4, wherein said wiring is formed on a surface layer or in the interior of said lamination substrate.

11. The antenna switch circuit according to claim 1, wherein said shunt capacitor is configured by a chip component.

12. The antenna switch circuit according to claim 1, wherein a serial connection circuit of a plurality of first to n-th through-side field effect transistors are used instead of said first to n-th through-side field effect transistors, and a serial connection circuit of a plurality of first to n-th shunt-side field effect transistors are used instead of said first to n-th shunt-side field effect transistors.

13. A composite high frequency part using said antenna switch circuit according to claim 1.

14. A mobile communication device using said antenna switch circuit according to claim 1.

15. A mobile communication device using said composite high frequency part according to claim 13.

16. A composite high frequency part using said antenna switch circuit according to claim 2.

17. A composite high frequency part using said antenna switch circuit according to claim 3.

18. A composite high frequency part using said antenna switch circuit according to claim 4.

19. A composite high frequency part using said antenna switch circuit according to claim 5.

20. A composite high frequency part using said antenna switch circuit according to claim 6.

21. A composite high frequency part using said antenna switch circuit according to claim 7.

22. A composite high frequency part using said antenna switch circuit according to claim 8.

23. A composite high frequency part using said antenna switch circuit according to claim 9.

24. A composite high frequency part using said antenna switch circuit according to claim 10.

25. A composite high frequency part using said antenna switch circuit according to claim 11.

26. A composite high frequency part using said antenna switch circuit according to claim 12.

27. A mobile communication device using said antenna switch circuit according to claim 2.

28. A mobile communication device using said antenna switch circuit according to claim 3.

29. A mobile communication device using said antenna switch circuit according to claim 4.

30. A mobile communication device using said antenna switch circuit according to claim 5.

31. A mobile communication device using said antenna switch circuit according-to claim 6.

32. A mobile communication device using said antenna switch circuit according to claim 7.

33. A mobile communication device using said antenna switch circuit according to claim 8.

34. A mobile communication device using said antenna switch circuit according to claim 9.

35. A mobile communication device using said antenna switch circuit according to claim 10.

36. A mobile communication device using said antenna switch circuit according to claim 11.

37. A mobile communication device using said antenna switch circuit according to claim 12.

38. A mobile communication device using said composite high frequency part according to claim 16.

39. A mobile communication device using said composite high frequency part according to claim 17.

40. A mobile communication device using said composite high frequency part according to claim 18.

41. A mobile communication device using said composite high frequency part according to claim 19.

42. A mobile communication device using said composite high frequency part according to claim 20.

43. A mobile communication device using said composite high frequency part according to claim 21.

44. A mobile communication device using said composite high frequency part according to claim 22.

45. A mobile communication device using said composite high frequency part according to claim 23.

46. A mobile communication device using said composite high frequency part according to claim 24.

47. A mobile communication device using said composite high frequency part according to claim 25.

48. A mobile communication device using said composite high frequency part according to claim 26.
